(19) United States
(12) Patent Application Publication
(10) Pub. No.: US 2020/0272953 A1
(43) Pub. Date: Aug. 27, 2020

(54) USING A STATUS CENTRIC VIEW FOR ALTERNATIVE RECOMMENDATIONS

(71) Applicant: GOOGLE LLC, Mountain View, CA (US)

(72) Inventors: Nick Ke Ning, Bedford, MA (US); Stephen Leslie Peters, Cambridge, MA (US); Yi Wang, Acton, MA (US); Gerhard Wetzel, Mountain View, CA (US); Stefan Frank, Belmont, MA (US); Jose Antonio Martinez, Avon, MA (US)

(21) Appl. No.: 16/288,082

(22) Filed: Feb. 27, 2019

(51) Int. Cl. G06Q 10/02; G06F 16/2457; G06F 16/248

(52) U.S. Cl. CPC G06Q 10/025; G06F 16/248; G06F 16/24578

(57) ABSTRACT

Methods, systems, and apparatus, including computer programs encoded on a computer storage medium, for determining alternative trip itineraries. A method includes obtaining current trip status information for a plurality of trips; using the current trip status information to determine that a user trip itinerary is delayed or cancelled; determining one or more alternative trip itineraries to the user itinerary, including: obtaining a collection of candidate alternative trip itineraries occurring within a specified time frame and that correspond to an origin and destination of the user itinerary, determining current trip status information for the candidate alternative trip itineraries, ranking the collection of candidate alternative trip itineraries according to one or more criteria, and selecting a specified number of the highest ranked candidate alternative trips to generate a group of alternative trip itineraries; and providing one or more of the group of alternative trip itineraries for display on a user device.

### BACKGROUND

This specification relates to information retrieval.

Conventional online reservation sites allow users to identify and reserve items according to a specified itinerary. For example, a user can purchase a trip itinerary for a trip departing from one location on a particular date and arriving at another location. Typically, following the purchase of a particular trip itinerary, the user will follow the trip itinerary and complete the trip.

Existing trip itineraries can be affected by different factors, many of which may be out of control of the user. For example, trip delays and/or cancelations can be caused by weather conditions, equipment problems and/or other factors. Trip delays can occur or be predicted at various parts of an itinerary, such as before the itinerary commences or sometime after itinerary has commenced.

### SUMMARY

This specification describes technologies relating to determining alternative trip itineraries. In general, one innovative aspect of the subject matter described in this specification can be embodied in methods that include the actions of obtaining current trip status information for a plurality of trips; using the current trip status information to determine that a trip itinerary of a user is delayed or cancelled; determining one or more alternative trip itineraries to the trip itinerary that is delayed or cancelled, including: obtaining a collection of candidate alternative trip itineraries occurring within a specified time frame and that correspond to an origin and destination of the user itinerary, determining current trip status information for the candidate alternative trip itineraries, ranking the collection of candidate alternative trip itineraries according to one or more criteria, and selecting a specified number of the highest ranked candidate alternative trips to generate a group of alternative trip itineraries; and providing one or more of the group of alternative trip itineraries for display on a user device.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Determining that a trip itinerary of a user is delayed or cancelled includes obtaining the trip itinerary of the user and comparing the one or more legs of the trip itinerary of the user with the current trip status information. Ranking the collection of candidate alternative trip itineraries includes: grouping similar candidate alternative trip itineraries including grouping trips and grouping trip itineraries that share legs. Ranking the collection of candidate alternative trip itineraries includes: scoring each candidate alternative trip itinerary according to the one or more criteria including one or more of a date that the candidate alternative trip itinerary arrives at the destination or a carrier of the candidate alternative trip itinerary compared with the carrier of the user's trip itinerary. The scores of each candidate alternative trip itinerary are adjusted according to one or more of: destination arrival time of the alternative trip itinerary, duration of the alternative trip itinerary, or number of connections of the alternative trip itinerary. Filtering the highest ranked candidate alternative trip itineraries based on the current trip status to generate a group of alternative trip itineraries includes: using the current trip status of each highest ranked candidate alternative trip to estimate actual departure and arrival times including any connection times; and determining that the candidate alternative trip itinerary is valid for the user based on the current trip status estimates. Providing one or more alternative trip itineraries for display includes providing information indicating the trip status of each alternative trip itinerary. Providing one or more alternative trip itineraries for display includes ordering the one or more alternative trip itineraries according to the estimated actual times instead of scheduled times for each alternative trip itinerary.

Particular embodiments of the subject matter described in this specification can be implemented so as to realize one or more of the following advantages. A user can be informed of available options for alternative trip itineraries when an itinerary of the user is delayed or cancelled. A user can be automatically informed of alternative trip itineraries, which can save time and which can increase the number of alternative trip itineraries to which a user is able to connect. A user can use alternative trip itinerary information when negotiating with a carrier after the user's itinerary is delayed or cancelled. Current trip status information can be used to generate accurate, up-to-date alternative trip itineraries.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment 100 for providing alternative flight itineraries to a user.

FIG. 2A is a block diagram of an example environment that includes a travel system.

FIG. 2B is a block diagram of an example alternative flight determination engine.

FIG. 3A illustrates an example current itinerary user interface.

FIG. 3B illustrates an example alternative itineraries summary user interface.

FIG. 3C illustrates an example alternative itineraries detailed view user interface.

FIG. 4A is flow diagram of an example method for providing one or more alternative flight itineraries for display on a user device.

FIG. 4B is flow diagram of an example method for determining one or more alternative flight itineraries.

Like reference numbers and designations in the various drawings indicate like elements.

### DETAILED DESCRIPTION

Users can book travel itineraries, for example, by using an online booking site. A travel re-accommodation system can monitor current flight status information for a booked itinerary and can determine that a flight itinerary of a user is delayed or cancelled based on the current flight status information. The travel re-accommodation system can determine one or more alternative flight itineraries for the user and provide one or more alternative flight itineraries for display on a user device of the user. The displayed alternative flight itineraries can be, for example, a group of alternative flight itineraries selected from a ranking and filtering of a collection of candidate alternative flight itineraries. In particular, a current status of the alternative flight itineraries can be used in ranking and filtering the collection of candidate alternative flight itineraries.

For situations in which the systems discussed here collect information about users, or may make use of information about users, the users may be provided with an opportunity to control whether programs or features collect user information (e.g., information about a user's social network, social actions or activities, profession, demographics, a user's preferences, or a user's current location), or to control whether and/or how to receive content from a content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information about the user is collected and used by a content server.

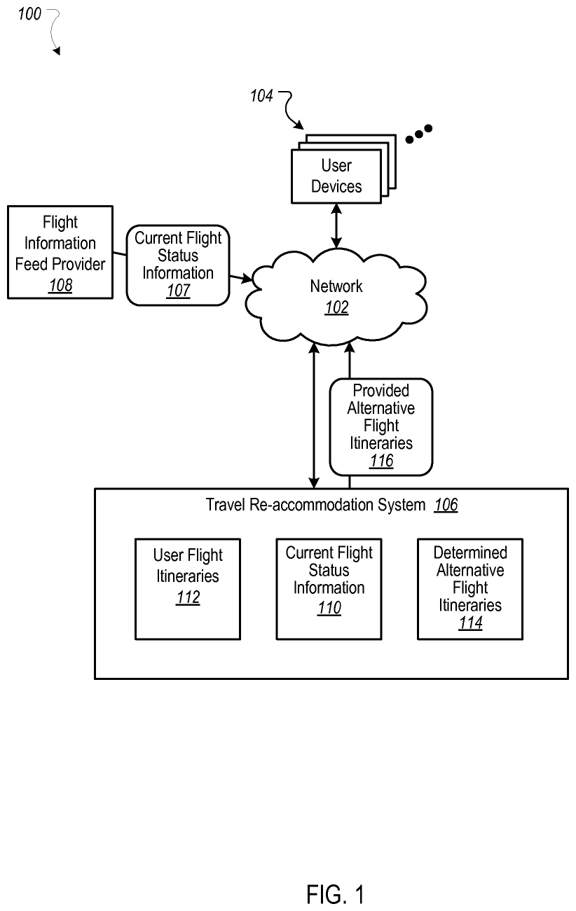

FIG. 1 is a block diagram of an example environment 100 for providing alternative flight itineraries to a user. The example environment 100 includes a network 102, such as a local area network (LAN), a wide area network (WAN), the Internet, or a combination thereof. The network 102 connects user devices 104 to a travel re-accommodation system 106. The example environment 100 may include many user devices 104, which can each be associated with one or more users.

A user device 104 is an electronic device that is under control of a user and is capable of requesting and receiving resources over the network 102. Example user devices 104 include personal computers, tablet computers, mobile communication devices (e.g., smartphones), televisions, set top boxes, personal digital assistants and other suitable devices that can send and receive data over the network 102. A user device 104 typically includes one or more user applications, such as a web browser, to facilitate the sending and receiving of data over the network 102. A user of a user device 104 can, for example, use a web browser to search for a particular travel itinerary, including a flight itinerary.

The travel re-accommodation system 106 can receive current flight status information 107 from a flight information feed provider 108. The current flight status information 107 can be, for example, real-time flight status information for flights that have an upcoming scheduled departure time within a predetermined time (e.g., twenty four hours) of transmission of the current flight status information 107. The travel re-accommodation system 106 can store the received current flight status information 107 in a current flight status information data store 110. The travel re-accommodation system 106 can receive the current flight status information 107 on a periodic basis (e.g., every five minutes). In some implementations, the flight information feed provider 108 pushes the current flight status information 107 to the travel re-accommodation system 106. In some implementations, the travel re-accommodation system 106 pulls the current flight status information 107 from the flight information feed provider 108. The flight information feed provider 108 can be, for example, one or more carriers. As another example, the flight information feed provider 108 can be a third party flight monitoring system or some other third party aggregator. In some implementations, the travel re-accommodation system 106 receives current flight status information from multiple feed providers and aggregates the received current flight status information in the data store 110.

As described in more detail below, the travel re-accommodation system 106 can determine when a user has purchased a flight itinerary, for users who have given permission for such a determination. Determined user flight itineraries can be stored in a user flight itineraries data store 112. The current flight status information 107 can include current status information for flight itineraries stored in the user flight itineraries data store 112 and for other flight itineraries.

The travel re-accommodation system 106 can use the current flight status information stored in the data store 110 to determine that one or more flight legs from the user itinerary in the data store 112 have been delayed or cancelled. A flight leg is a routing between an origin and a destination city. For each delayed or cancelled flight leg, the travel re-accommodation system 106 can determine one or more alternative flight itineraries 114 to the current flight itinerary including one or more delayed or cancelled flight legs. In particular, the current flight status information can also be used in determining the one or more alternative flight itineraries 114, as described in greater detail below. One or more of the determined alternative flight itineraries 114 can be provided to a respective user device 104 for display (e.g., as illustrated by provided alternative flight itineraries 116).

The alternative flight itineraries 116 can be provided to a user device 104 automatically, in response to the determination that a flight itinerary of the user of the user device 104 has been delayed or cancelled. For example, the alternative flight itineraries 116 can be provided as a push notification sent to a user application. As another example, the alternative flight itineraries 116 can be sent as an electronic message, such as a text or email message. The user can view the provided alternative flight itineraries 116 to determine flight options that are available as a replacement for the delayed or cancelled flight itinerary. As described in more detail below, the provided alternative flight itineraries 116 can include information that allows the user to make an informed decision when choosing an alternative flight itinerary. The automatic providing of alternative flight itinerary information can result in the user knowing available travel-change options at an earlier time as compared to the user attempting to manually or otherwise determine alternative flight itineraries. The automatic providing of alternative flight itinerary information can make the user aware of alternative flight itineraries that are currently available but that might soon be unavailable (e.g., unfeasible, due to impending departure times). Accordingly, the automatic providing of alternative flight itinerary information can result in the user being able to select from a larger number of alternative flight itineraries as compared to the user attempting to, for example, manually determine alternative flight itineraries.

The user can use alternative flight itinerary information, for example, when discussing or negotiating travel change options with a carrier associated with the delayed or cancelled flight itinerary. The provided alternative flight itineraries 116 can include, for example, available flight itineraries that are not known to the carrier and/or flight itineraries that a carrier representative might not suggest (e.g., initially or otherwise) to the user. The provided alternative flight itineraries 116 can be used by the user, for example, as leverage when negotiating with the carrier. The carrier, for example, may suggest an alternative itinerary that matches a cancelled or delayed travel leg, but not an alternative itinerary that results in the user reaching their final destination. The alternative flight itinerary information can inform the user as to available options for reaching their final destination.

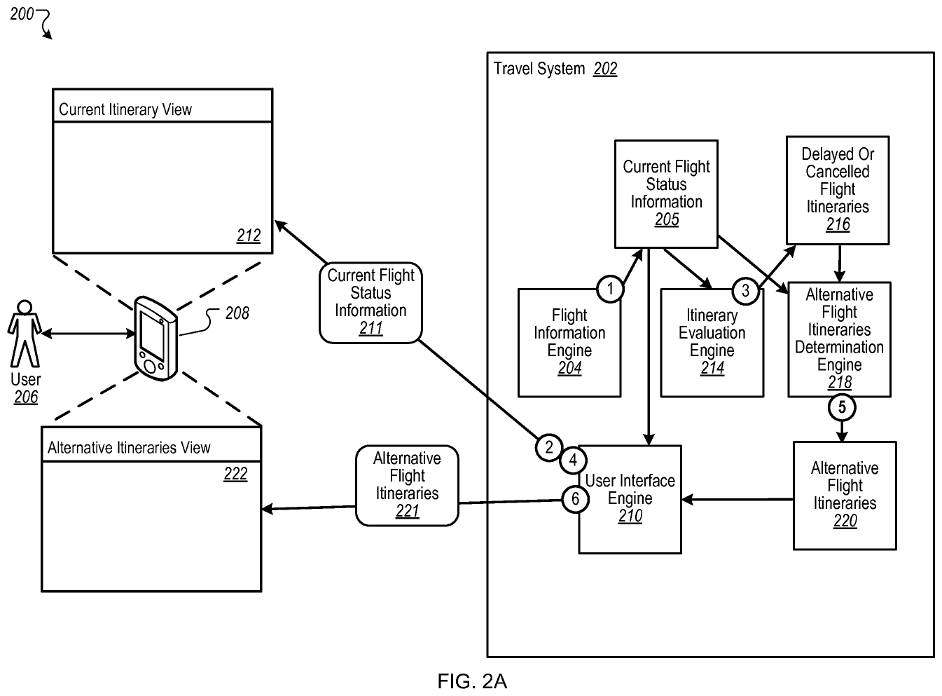

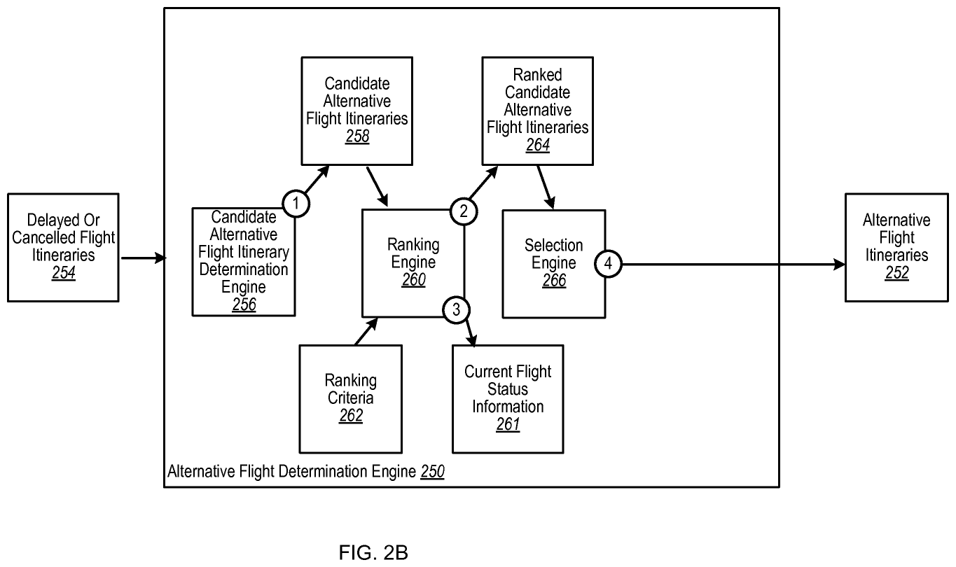

FIG. 2A is a block diagram of an example environment 200 that includes a travel system 202. In stage 1, a flight information engine 204 obtains current flight status information 205 for a collection of flights. For example, the flight information engine 204 can obtain current flight status information for a flight itinerary of a user 206 associated with a user device 208 and for other flights.

In stage 2, a user interface engine 210 can optionally provide current flight status information 211 for a flight itinerary of the user 206 to the user device 208, such as for presentation in a current itinerary view user interface 212.

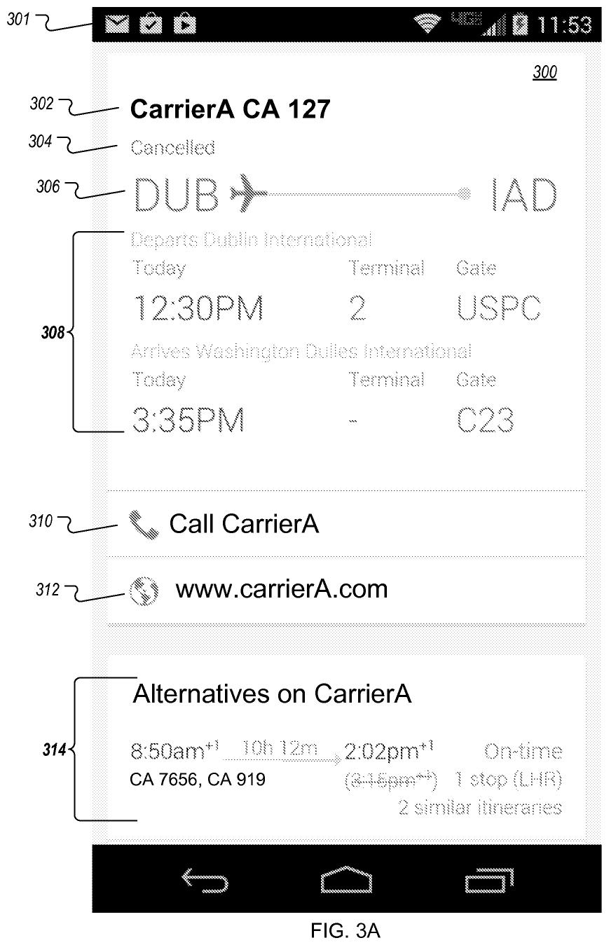

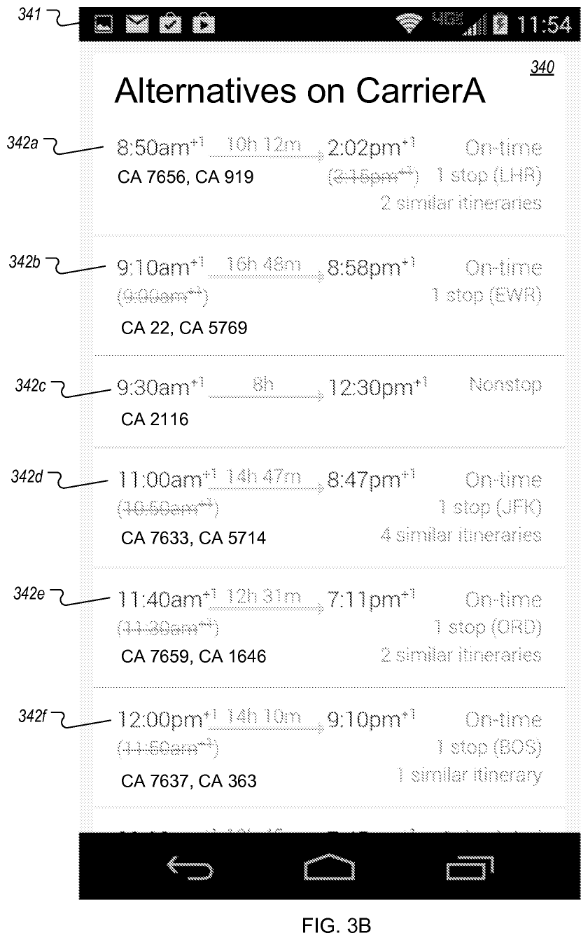

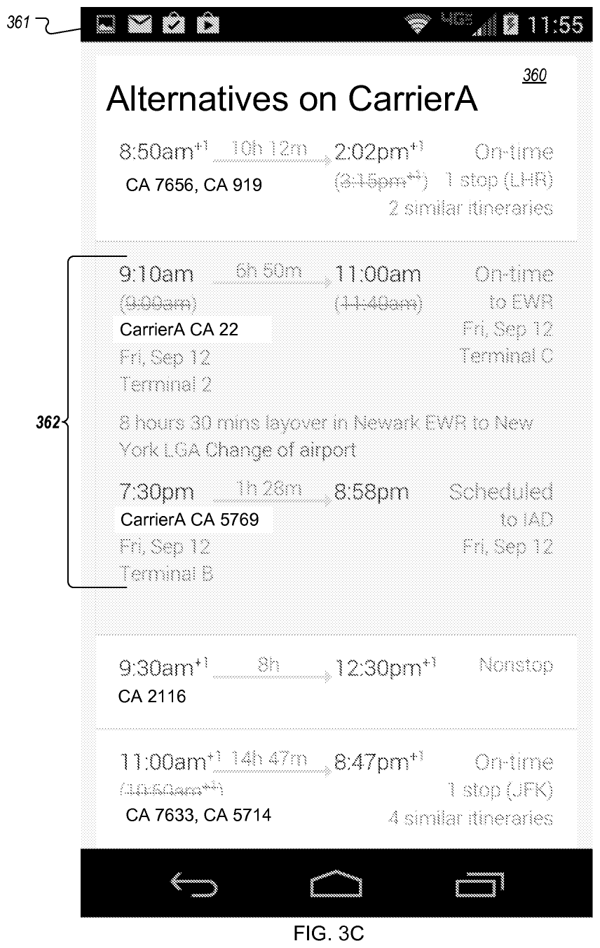

For example, FIG. 3A illustrates an example current itinerary user interface 300 displayed on a user device 301. The user interface 300 includes carrier and flight number information 302, current flight status 304 (e.g., scheduled, on-time, delayed, cancelled, diverted, or landed, and when delayed, an estimated arrival or departure time), and departure and arrival locations 306. A departure and arrival detail area 308 includes departure and arrival time, terminal, and gate information. Controls 310 and 312 can be used to view a web site of the carrier or to call the carrier, respectively. As described below, an alternatives area 314 can display information about one or more alternative itineraries to the current flight in response to the user device 301 receiving a notification that the current flight is delayed or cancelled. When the user's current flight is not delayed or cancelled, the alternatives area 314 can be excluded from the user interface 300.

Referring again to FIG. 2A, in stage 3, an itinerary evaluation engine 214 can use the current flight status information 205 to determine delayed or cancelled flight itineraries 216 representing user flight itineraries that have one or more legs impacted by a delayed or cancelled flight. The itinerary evaluation engine 214 can determine, for example, that a flight itinerary of the user 206 includes a flight leg that is delayed or cancelled. In stage 4, the user interface engine 210 can provide updated current flight status information 211 to the user device 208 that indicates that the flight itinerary of the user 206 is delayed or cancelled. For example, in reference to FIG. 3A, the current flight status can be updated.

In stage 5, an alternative flight itineraries determination engine 218 can determine one or more alternative flight itineraries that includes one or more alternative flight legs that replace the delayed or cancelled flights in the user's itinerary. For example, the alternative flight itineraries determination engine 218 can determine alternative flight itineraries 220 that include one or more flight legs that are alternatives to a delayed or cancelled flight of the user 206. The alternative flight itineraries determination engine 218 is described in more detail below with reference to FIG. 2B.

In stage 6, the user interface engine 210 can provide, for example, the alternative flight itineraries 220 for display on the user device 208 (e.g., as illustrated by provided alternative flight itineraries 221). For example, some or all of the alternative flight itineraries 221 can be displayed, for example, in a notification area of the current itinerary view user interface 212 (e.g., along with a notification that a current flight itinerary of the user 206 is delayed or cancelled). In reference to FIG. 3A, some or all of the alternative flight itineraries 221 can be displayed in the alternatives area 314.

In some implementations, the user 206 can, for example, select a user interface control on the current itinerary view 212 to view an alternative itineraries view user interface 222 to view more information about the alternative flight itineraries 221. As another example, the alternative itineraries view user interface 222 can be displayed automatically in response to receipt of the alternative flight itineraries 221.

For example, FIG. 3B illustrates an example alternative itineraries summary user interface 340 displayed on a user device 341. The alternative itineraries summary user interface 340 can be displayed as a push notification, for example, in response to the user device 341 receiving a notification that an itinerary of the user of the user device 341 has been delayed or cancelled. As another example, the alternative itineraries summary user interface 340 can be displayed in response to the user selecting a user interface control, such as a control included in the current itinerary user interface 300 described above with respect to FIG. 3A.

The alternative itineraries summary user interface 340 includes alternative itineraries 342a-342f The alternative itineraries 342a-342f may be determined, for example, by an alternative flight itineraries determination engine (e.g., as described above with respect to FIG. 2A and below with respect to FIG. 2B). The alternative itineraries 342a-342f can be itineraries that include one or more alternative flight legs to the flight legs of the user itinerary that has been delayed or cancelled. The alternative itineraries 342a-342f can be sorted, for example, by departure time. Although the alternative itineraries 342a-342f are each for a same carrier (e.g., “Carrier A”), the alternative itineraries summary user interface 340 can present itineraries from multiple carriers. Each of the alternative itineraries 342a-342f includes a schedule departure time, a scheduled arrival time, a current flight status, an actual departure time (if applicable), an updated (e.g., estimated arrival time (if applicable), flight code(s), and number of stops. Other flight information can be included in an alternative itinerary 342a-342f. In some implementations, an alternative itinerary 342a-342f can be selected to view additional details about the selected alternative itinerary 342a-342f.

For example, FIG. 3C illustrates an example alternative itineraries detailed view user interface 360 displayed on a user device 361. The alternative itineraries detailed view user interface 360 can be displayed, for example, in response to selected of an alternative itinerary 342a-342f as described above with respect to FIG. 3B. For example, the alternative itineraries detailed view user interface 360 includes a detailed alternative itinerary area 360 which can be displayed, for example, in response to user selection of the alternative itinerary 342b of FIG. 3B. For example, the alternative itinerary 342b can expand into the detailed alternative itinerary area 360 in response to user selection of the alternative itinerary 342b. The detailed alternative itinerary area 360 includes, for example, information about travel legs (e.g., leg duration, departing and arriving terminals, and gates when available) and stops (e.g., intervening airports, stop duration). In some implementations, the detailed itinerary area 360 includes one or more user interface controls that are configured, for example, to enable the user to purchase the alternative itinerary 342b, contact Carrier A, or view a web site associated with Carrier A.

FIG. 2B is a block diagram of an example alternative flight determination engine 250. The alternative flight determination engine 250 can determine one or more alternative flight itineraries 252 for each itinerary included in a set of one or more delayed or cancelled flight itineraries 254. In some implementations, the alternative flight determination engine 250 can determine one or more alternative flight itineraries 252 in response to receiving a notification that a user itinerary has been delayed or cancelled.

In stage 1, a candidate alternative flight itinerary determination engine 256 determines a collection of candidate alternative flight itineraries 258 occurring within a specified time frame that correspond to an origin and destination of a delayed or cancelled user itinerary.

In stage 2, a ranking engine 260 determines current flight status information 261 for the candidate alternative flight itineraries 258. The current flight status information 261 can indicate, for example, whether respective candidate alternative flight itineraries are delayed, on-time, or cancelled.

In stage 3, the ranking engine 260 ranks the candidate alternative flight itineraries 258 according to one or more criteria 262 to generate a set of ranked candidate alternative flight itineraries 264. The one or more criteria 262 are described in more detail below. The ranking engine 260 can perform the ranking, based at least in part, on the current flight status information 261.

In stage 4, a selection engine 266 selects the alternative flight itineraries 252 based on the ranking of the highest ranked candidate alternative flight itineraries 264. For example, the selection engine 266 can select a specified number (e.g., five) of the highest ranked candidate alternative flight itineraries 264. As another example, the selection engine 266 can select ranked candidate alternative flight itineraries 264 that have a ranking above a threshold ranking.

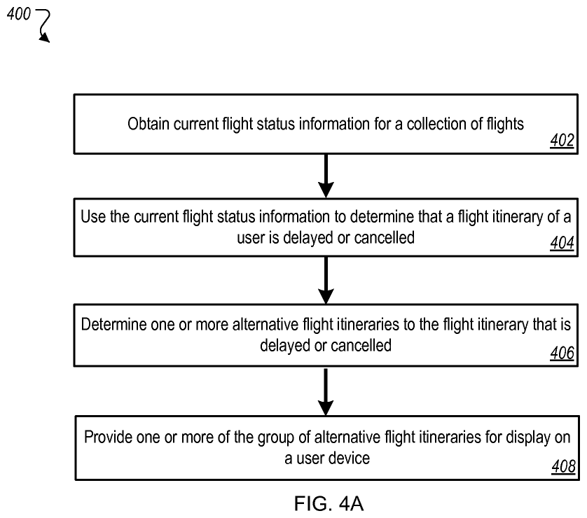

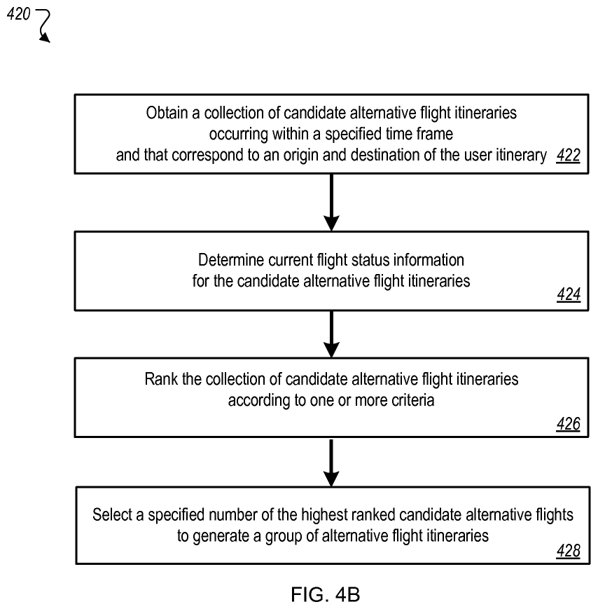

FIG. 4A is flow diagram of an example method 400 for providing one or more alternative flight itineraries for display on a user device. For convenience, the method 400 will be described with respect to a system, including one or more computing devices, that performs the method 400.

The system obtains current flight status information for a collection of flights (step 402). The current flight status information can be obtained, for example, from a feed of flight status information, e.g., flight information feed provider 108 of FIG. 1.

The system uses current flight status information to determine that a flight itinerary of a user includes one or more flight legs that are delayed or cancelled (step 404). For example, a departure for an initial leg or a subsequent leg of a user itinerary may be delayed or cancelled. In some implementations, a determination can be made that a flight itinerary is in danger of being delayed but not necessarily delayed. For example, the arrival of an airplane to be used on a next travel leg may possibly be delayed, due to a delayed departure of that airplane on its current flight.

The system determines one or more alternative flight itineraries that are alternatives to the flight itinerary that is delayed or cancelled (step 406).

For example, FIG. 4B is flow diagram of an example method 420 for determining one or more alternative flight itineraries. For convenience, the method 420 will be described with respect to a system, including one or more computing devices, that performs the method 420.

The system obtains a collection of candidate alternative flight itineraries occurring within a specified time frame and that correspond to an origin and destination of the user itinerary (step 422). If a connecting flight is delayed or cancelled, the candidate alternative flight itineraries can be alternatives for a next leg of the user flight itinerary. Candidate alternative flight itineraries can be obtained from a feed or a data store. The specified time frame can be, for example, within forty eight hours of a scheduled arrival time of a user itinerary. In some implementations, similar candidate alternative flight itineraries are grouped. For example, codeshare flights and/or flight itineraries that share legs or leg connections can be grouped. A codeshare flight can be operating for multiple airlines and can appear multiple times, for example, in a feed of flight information. Grouping can include, for example, merging the grouped candidate alternative flight itineraries into a single candidate alternative flight itinerary. Grouping or merging candidate alternative flight itineraries can result in less duplicate (or nearly duplicate) itineraries being included in the collection of candidate alternative flight itineraries.

The system determines current flight status information for the candidate alternative flight itineraries (step 426). Flight status information can indicate, for example, whether a candidate alternative flight itinerary is on-time, delayed, or cancelled.

The system ranks the collection of candidate alternative flight itineraries according to one or more criteria (step 426). The criteria can include one or more of a date that the candidate alternative flight itinerary arrives at the destination or a carrier of the candidate alternative flight itinerary as compared with the carrier of the user's fight itinerary. For example, same-day flights can be considered more important than flight itineraries that arrive on later dates. As another example, a candidate alternative flight itinerary that has a carrier that matches the carrier of the user's flight itinerary (or that has a carrier that is an affiliated (e.g., partner) carrier to the carrier of the user's flight itinerary) can be considered more important than candidate alternative flight itineraries that have carriers that are not affiliated with the carrier of the user's flight itinerary. The criteria can include flight-status based criteria. For example, the criteria can filter out cancelled candidate alternative flight itineraries. Other flight-status examples are described below.

The criteria (or in some implementations, score-adjustment factors) can also include one or more of destination arrival time, duration or number of connections of the candidate alternative flight itinerary. For example, candidate alternative flight itineraries that arrive the earliest can be ranked higher than other candidate alternative flight itineraries. Candidate alternative flight itineraries that take a least amount of time between departure and arrival can be ranked higher than other candidate alternative flight itineraries. Candidate alternative flight itineraries that use a fewest number of connections can be ranked higher than other candidate alternative flight itineraries. As another example, the criteria can include time-inflight (e.g., candidate alternative flight itineraries with more time-in-flight can be ranked lower than candidate alternative flight itineraries with less time-in-flight).

In some implementations, the criteria includes a determined risk factor. For example, a weather risk can be determined for each candidate alternative flight itinerary. For example, if the delayed or cancelled flight itinerary is delayed or cancelled due to winter weather in Boston and winter-weather cancellations or delays have also been determined for one or more Chicago arrivals, a candidate alternative flight itinerary that routes through Dallas may be ranked higher than a candidate alternative flight itinerary that routes through Chicago, even when the Dallas itinerary takes longer and the Chicago itinerary is currently not cancelled.

A determined risk-factor can affect other criteria. For example, when an imminent weather-based risk is determined, a weight of a departure time criteria can be increased (e.g., it may be desirable to depart before a weather event occurs).

As another risk-based example, the criteria can include a likelihood of the user being able to make a connection (e.g., based on estimated arrival time for a connecting flight). In some implementations, a risk factor is weighted based on whether a connection flight is a last connecting flight of the day. For example, suppose that a first candidate alternative flight itinerary routes the user to Chicago with a tight connection and is a last connecting flight of the day to the user's final destination. Suppose that a second candidate alternative flight itinerary also routes the user to Chicago with a tight connection but there are four other, later connections that day from Chicago to the user's final destination. The first candidate alternative flight itinerary can be determined to be more risky than the second candidate alternative flight itinerary since the first candidate alternative flight itinerary has a higher risk of the user being stranded overnight in Chicago.

The system selects a specified number of the highest ranked candidate alternative flights to generate a group of alternative flight itineraries (step 428). The specified number can be a predetermined number (e.g., ten). As another example, the specified number can be the number of ranked candidate alternative flight itineraries that have a ranking above a threshold ranking.

Referring again to FIG. 4A, one or more of the group of alternative flight itineraries are provided for display on a user device (step 308). In some implementation, information indicating the current flight status of each alternative flight itinerary is provided. Flight status can include, for example, on-time, scheduled, delayed, cancelled, diverted, or landed. In some implementations, flight status is shown using color coding of different statuses. The one or more alternative flight itineraries can be ordered according to estimated actual times instead of scheduled times for each alternative flight itinerary. Terminal and gate information can be provided for each alternative flight itinerary.

In some implementations, the group of alternative flight itineraries are grouped into a first group of flight itineraries having the same carrier as the delayed or cancelled flight itinerary, a second group of flight itineraries on a partner carrier of the carrier of the delayed or cancelled flight itinerary, and a third group of other flight itineraries. Flight itineraries can be sorted within respective groups, for example according to departure time.

In some implementations, alternative flight itineraries can be initially shown in a summary view, and a respective alternative flight itinerary can be shown with more information presented in a detailed view upon selection of the alternative flight itinerary in the summary view. In some implementations, the user can toggle between the summary view and the detailed view. In some implementations, the alternative flight itinerary information is automatically displayed in a notification area (e.g., a popup window) on a user device, to notify the user of a delayed or cancelled flight and to present the alternative flight itineraries.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method to render graphical user interfaces to provide information about alternative trips, comprising, by one or more computing devices:
obtaining current trip status information for a plurality of trips;
comparing the current trip status information to a trip itinerary of a user to determine that the trip itinerary of the user is delayed or canceled;
in response to determining that the trip itinerary of the user is delayed or canceled, determining a group of two or more alternative trip itineraries to the trip itinerary that is delayed or canceled, by:
obtaining a collection of candidate alternative trip itineraries occurring within a specified time frame and that correspond to an origin and destination of the trip itinerary of the user,
determining current trip status information for the candidate alternative trip itineraries, and
ranking the collection of candidate alternative trip itineraries according to one or more criteria,
providing instructions to a user computing device causing the user computing device to render, via a graphical user interface, an itinerary summary interface comprising the trip itinerary of the user that is delayed or canceled, the itinerary summary interface comprising a link to display alternative trips;
receiving, via the user computing device, a selection of the link to display alternative trips; and
in response to receiving, the selection of the link to display alternative trips, providing instructions to the user computing device causing the user computing device to render, via a graphical user interface, an alternative itineraries summary interface comprising the ranked alternative trip itineraries, each of the ranked alternative trip itineraries comprising a respective current trip status.

2. The method of claim 1, wherein determining that a trip itinerary of a user is delayed or canceled comprises obtaining the trip itinerary of the user and comparing one or more legs of the trip itinerary of the user with the current trip status information.

3. The method of claim 1, wherein ranking the collection of candidate alternative trip itineraries comprises:
grouping similar candidate alternative trip itineraries including grouping trips and grouping trip itineraries that share legs.

4. The method of claim 1, wherein ranking the collection of candidate alternative trip itineraries comprises:
scoring each candidate alternative trip itinerary according to the one or more criteria including one or more of a date that the candidate alternative trip itinerary arrives at the destination or a carrier of the candidate alternative trip itinerary compared with the carrier of the user's trip itinerary.

5. The method of claim 4, wherein the scores of each candidate alternative trip itinerary is adjusted according to one or more of:
a destination arrival time of the alternative trip itinerary;
a duration of the alternative trip itinerary; and
a number of connections of the alternative trip itinerary.

6. The method of claim 1, wherein filtering the highest ranked candidate alternative trip based on the current trip status to generate a group of alternative trip itineraries comprises:
using the current trip status of each highest ranked candidate alternative trip to estimate actual departure and arrival times including any connection times; and
determining that the candidate alternative trip itinerary is valid for the user based on the current trip status estimates.

7. The method of claim 1, wherein providing one or more alternative trip itineraries for display comprises providing information indicating the trip status of each alternative trip itinerary.

8. The method of claim 1, wherein providing one or more alternative trip itineraries for display comprises ordering the one or more alternative trip itineraries according to the estimated actual times instead of scheduled times for each alternative trip.

9. A system to provide graphical user interfaces that provide information concerning alternative trip itineraries comprising:
a storage device; and
one or more processors communicatively coupled to the storage device, wherein the one or more processors are configured to execute application code instructions stored in the storage device to cause the system to:
obtain current trip status information for a plurality of trips;
compare the current trip status information to a trip itinerary of a user to determine that the trip itinerary of the user is delayed or canceled;
in response to determining that the trip itinerary of the user is delayed or canceled, determine a group of two or more alternative trip itineraries to the trip itinerary that is delayed or canceled, by:
obtaining a collection of candidate alternative trip itineraries occurring within a specified time fame and that correspond to an origin and destination of the trip itinerary of the user,
determining current trip status information for the candidate alternative trip itineraries, and
ranking the collection of candidate alternative trip itineraries according to one or more criteria,
provide instructions to a user computing device causing the user computing device to render, via a graphical user interface, an itinerary summary interface comprising the trip itinerary of the user that is delayed or canceled, the itinerary summary interface comprising a link to display alternative trips;
receive, via the user computing device, a selection of the link to display alternative trips; and
in response to receiving, the selection of the link to display alternative trips, provide instructions to the user computing device causing the user computing device to render, via a graphical user interface, an alternative itineraries summary interface comprising the ranked alternative trip itineraries, each of the ranked alternative trip itineraries comprising a respective current trip status.

10. The system of claim 9, wherein determining that a trip itinerary of a user is delayed or canceled comprises obtaining the trip itinerary of the user and comparing one or more legs of the trip itinerary of the user with the current trip status information.

11. The system of claim 9, wherein ranking the collection of candidate alternative trip itineraries comprises:
grouping similar candidate alternative trip itineraries including grouping trips and grouping trip itineraries that share legs.

12. The system of claim 9, wherein ranking the collection of candidate alternative trip itineraries comprises:
scoring each candidate alternative trip itinerary according to the one or more criteria including one or more of a date that the candidate alternative trip itinerary arrives at the destination or a carrier of the candidate alternative trip itinerary compared with the carrier of the user's trip itinerary.

13. The system of claim 12, wherein the scores of each candidate alternative trip itinerary is adjusted according to one or more of:
a destination arrival time of the alternative trip itinerary;
a duration of the alternative trip itinerary; or
a number of connections of the alternative trip itinerary.

14. The system of claim 9, wherein filtering the highest ranked candidate alternative trip itineraries based on the current trip status to generate a group of alternative trip itineraries comprises:
using the current trip status of each highest ranked candidate alternative trip to estimate actual departure and arrival times including any connection times; and
determining that the candidate alternative trip itinerary is valid for the user based on the current trip status estimates.

15. A computer program product to provide graphical user interfaces that provide information concerning alternative trip itineraries, comprising:
a non-transitory computer-readable medium having computer-executable program instructions embodied thereon that when executed by one or more computers cause the one or more computers to:
obtain current trip status information for a plurality of trips;
compare the current trip status information to a trip itinerary of a user to determine that the trip itinerary of the user is delayed or canceled;
in response to determining that the trip itinerary of the user is delayed or canceled, determine a group of two or more alternative trip itineraries to the trip itinerary that is delayed or canceled, by:
obtaining a collection of candidate alternative trip itineraries occurring within a specified time fame and that correspond to an origin and destination of the trip itinerary of the user,
determining current trip status information for the candidate alternative trip itineraries, and
ranking the collection of candidate alternative trip itineraries according to one or more criteria,
provide instructions to a user computing device causing the user computing device to render, via a graphical user interface, an itinerary summary interface comprising the trip itinerary of the user that is delayed or canceled, the itinerary summary interface comprising a link to display alternative trips;
receive, via the user computing device, a selection of the link to display alternative trips; and
in response to receiving, the selection of the link to display alternative trips, provide instructions to the user computing device causing the user computing device to render, via a graphical user interface, an alternative itineraries summary interface comprising the ranked alternative trip itineraries, each of the ranked alternative trip itineraries comprising a respective current trip status.

16. The computer program product of claim 15, wherein determining that a trip itinerary of a user is delayed or canceled comprises obtaining the trip itinerary of the user and comparing one or more legs of the trip itinerary of the user with the current trip status information.

17. The computer program product of claim 15, wherein ranking the collection of candidate alternative trip itineraries comprises:
grouping similar candidate alternative trip itineraries including grouping trips and grouping trip itineraries that share legs.

18. The computer program product of claim 15, wherein ranking the collection of candidate alternative trip itineraries comprises:
scoring each candidate alternative trip itinerary according to the one or more criteria including one or more of a date that the candidate alternative trip itinerary arrives at the destination or a carrier of the candidate alternative trip itinerary compared with the carrier of the user's trip itinerary.

19. The computer program product of claim 18, wherein the score of each candidate alternative trip itinerary is adjusted according to one or more of:
a destination arrival time of the alternative trip itinerary;
a duration of the alternative trip itinerary; or
a number of connections of the alternative trip itinerary.

20. The computer program product of claim 15, wherein filtering the highest ranked candidate alternative trip itineraries based on the current trip status to generate a group of alternative trip itineraries comprises:
using the current trip status of each highest ranked candidate alternative trip to estimate actual departure and arrival times including any connection times; and
determining that the candidate alternative trip itinerary is valid for the user based on the current trip status estimates.
